(19) United States
(12) Patent Application Publication
(10) Pub. No.: US 2026/0120912 A1
(43) Pub. Date: Apr. 30, 2026

(54) ONE-DIMENSIONAL, ROOM-TEMPERATURE SUPERCONDUCTOR WITH CuS CHANNEL

(71) Applicant: HYUN TAK KIM, Williamsburg, VA (US)

(72) Inventor: HYUN TAK KIM, Williamsburg, VA (US)

(21) Appl. No.: 18/913,967

(22) Filed: Oct. 11, 2024

Related U.S. Application Data
(60) Provisional application No. 63/589,947, filed on Oct. 12, 2023.

(51) Int. Cl. H01B 1/02; H01B 12/00

(52) U.S. Cl. CPC H01B 1/026; H01B 12/00

(57) ABSTRACT

Superconductive diamagnetic compounds with CuS channel and a modified apatite structure, or other structures, at and above 0° C. and ambient pressure are described, along with methods for their synthesis and use. The compounds are characterized by an X-ray diffraction peak from CuS planes. The diamagnetic compounds can have a molecular formula Pb₁₀₋ₓCuₓ[P (O_{1-y}S_{y})₄]₆O_{1-z}S_{z}(PCPOSOS), where 2.5≤x≤10,0<y≤1, and 0<z≤1.

### TECHNICAL FIELD

The present invention relates to an ambient-pressure, room-temperature superconductor and its method of synthesis, particularly to a one-dimensional superconductor using a CuS channel.

### CROSS-REFERENCE TO RELATED APPLICATIONS

Reference 1, Lee, S., et al., The First Room-Temperature Ambient-Pressure Superconductor, arXiv:2307.12008 (2023).

Reference 2, Lee, S. et al., Superconductor Pb₍₁₀₋ₓ₎Cuₓ(PO₄)₆O with 0.9<x<1.1 showing levitation at room temperature and atmospheric pressure and mechanism, arXiv: 2307.12037 (2023).

Reference 3, Dan Garisto, LK-99 isn't a superconductor-how science sleuths solved the mystery, Nature 620 (2023) 705.

Reference 4, Prashant K. Jain, Superionic phase transition of copper (I) sulfide and its implication for purported superconductivity of LK-99, arXiv: 2308.05222v3 (2023).

Reference 5, Zhu et al., First order transition in Pb₁₀₋ₓCuₓ(PO₄)₆O (0.9<x<1.1) containing Cu₂S, arXiv: 2308.04353 (2023).

Reference 6, E. Hirahara, The physical properties of cuprous sulfides-semiconductors, J. Phys. Soc. Jpn. 6(1951) 422.

Reference 7, Puphal, P. et al., Single crystal synthesis, structure, and magnetism of Pb₁₀₋ₓCuₓ (PO₄) 6O, arXiv: 2308.06256 (2023).

Reference 8, Lee. S., et al., Room temperature and normal pressure superconducting ceramic compound, and method for manufacturing same, PCT patent WO2023027536.

Reference 8-2, Lee. S., et al., Room-temperature and atmospheric-pressure superconducting ceramic compound, and preparation method, PCT patent WO2023027537A1.

Reference 9, Kim, H. T., Room-temperature-super conducting Te driven by electron correlation, Sci. Rep. 11 (10329) 2021.

Reference 10, Zhang. H. T., et al., Controlled synthesis and characterization of covellite (CuS) nanoflakes, Materials Chemistry and Physics 98 (2006) 298.

Reference 11, Rajaram R, et al., Amperometric determination of Myo-inositol using a glassy carbon electrode modified with nanostructured copper sulfide, Microchim Acta 187(2020) 334.

Reference 12, Kim, H. T. et al., 2024 American Physical Society March Meeting, Abstract: A16.00002, Partial levitation, type-II-superconductor characteristic, at room temperature and atmospheric pressure in PCPOSOS.

Reference 13, Petr Cermak, Internet photos showing presentation screens presented by an inventor, Hyun-Tak Kim, at 2024 American Physical Society March Meeting in Reference 12. Hyperlinked internet address is “https://www.nextbigfuture.com/2024/03/Room Temperature Superconductor PCPOSOS Talk With Full Levitation Video|NextBigFuture.com”.

Reference 14, Kim, H., et al., The Potential Zero-Resistance Phenomenon of the Pb-Cu-P-S-O Compound and Its Synthesis Method, viXra: 2403.0040v2.

Reference 15, Kim, H. et al., Investigation of the Zero Resistance and Temperature-Dependent Superconductivity Phase Transition in Pb-Cu-P-S-O Compound, viXra: 2403.0144v2.

Reference 16, Habamahoro, T. et al., Replication and study of anomalies in LK-99the alleged ambient-pressure, room-temperature superconductor, Supercond. Sci. Technol. 37 (2024) 045004.

### FEDERALLY SPONSORED RESEARCH AND DEVELOPMENT

Not applicable

### BACKGROUND OF THE INVENTION

Room temperature, ambient pressure superconductors are highly desired in the field of materials science and technology because they offer numerous advantages over traditional superconductors, which typically require extremely low temperatures and high pressures to exhibit their superconducting properties including a diamagnetic repulsive characteristic to a magnet called Meissner effect.

Two arXiv preprints in references 1 and 2, (reference 1, Lee, S., et al. “The First Room-Temperature Ambient-Pressure Superconductor”, arXiv: 2307.12008 (2023): reference 2, Lec, S. et al. “Superconductor Pb₍₁₀₋ₓ₎Cuₓ(PO₄) 60 with 0.9<x<1.1 showing levitation at room temperature and atmospheric pressure and mechanism”, arXiv: 2307.12037 (2023)) filed within hours of each other in the summer of 2023 by overlapping groups of researchers in Korea reported signatures of superconductivity above room temperature and at ambient pressure using a material called LK-99. Reference 2 was written by one of the inventors in present patent. This development prompted worldwide experimental research efforts to replicate the results and definitely show room temperature superconductivity, so far without any clear success.

The chemical composition of LK-99 is reported to be approximately Pb₉Cu (PO₄)₆O. Compared to pure lead-apatite (Pb₁₀(PO₄)₆O), approximately one-tenth of Pb (II) ions in the apatite structure are replaced by Cu (II) ions.

The authors of Reference 1 revealed the presence of a Cu₂S compound in the X-ray diffraction pattern. They confirmed the chemical formula of Pb₁₋ₓCuₓ(PO₄)O without sulfur.

Garisto summarized (i) attempts to replicate the results with LK99, and (ii) consensus conclusions about the material, in reference 3 of a Nature article entitled “LK-99 isn't a superconductor—how science sleuths solved the mystery” (Nature620, 705-706 (2023)). One complication is that the published synthetic recipe to produce LK-99 was unbalanced and produced significant amounts of impurities, including copper (I) sulfide (Cu₂S).

Jain of reference 4 “Superionic phase transition of copper (I) sulfide and its implication for purported superconductivity of LK-99” arXiv: 2308.05222v3 (2023) described a characteristic phase transition of Cu₂S at 104° C. causing its resistivity to drop dramatically, which Jain postulated could account for some of the superconductivity-like behavior of the LK-99 mix. Zhu et al. of reference 5 (“First order transition in Pb₁₀₋ₓCuₓ(PO₄)₆O (0.9<x<1.1) containing Cu₂S”, arXiv: 2308.04353 (2023)) used different synthesis procedures to attempt to make LK-99 with different amounts of Cu₂S, resulting in variable properties based on the Cu₂S impurity content. It was known that CuzS with Cul+ (3d¹⁰) was an insulator undergoing the structural phase transition between ß and γ semiconductor phases near 116° C. in reference 6 (E. Hirahara, “The physical properties of cuprous sulfides-semiconductors”, J. Phys. Soc. Jpn. 6, 422 (1951)). This indicates that CuzS phase is far from superconductivity.

Puphal, P. et al. in reference 7 (“Single crystal synthesis, structure, and magnetism of Pb₁₀₋ₓCuₓ(PO₄)₆O”, arXiv: 2308.06256 (2023)) avoided introducing sulfur into the reaction in an attempt to produce pure LK-99. A single pure crystal was produced, with composition Pb_{8.8}Cu_{1.2}P₆O₂₅, which was demonstrated to be an insulator rather than a superconductor.

When LK99 was synthesized, the inventors disclosed in both Korean patent 10-2023-0030188 and PCT patent WO2023027536 of reference 8 “Room temperature and normal pressure superconducting ceramic compound, and method for manufacturing same” that they used lanarkite (Pb₂SO₅) as a raw material, which contains sulfur. As a result, LK99 can include sulfur. However, the quantity of sulfur was very small and considered an impurity. Nonetheless, the inventors disclosed in their original patent that sulfur is positioned at the phosphorus site of Pb₁₋ₓCuₓ(PO₄)₆O, as mentioned in paragraph of the Korean patent and paragraph of the PCT patent (reference 8). This is quite different from the main idea of present invention.

The chemical formula 1 in claim 1 of reference 8 was expressed as an omnibus claim, which includes many chemical formulas by combining various elements at respective clement positions. The physical characteristics of the respective chemical formulas and their synthesis methods were not described in the main text. Additionally, the chemical formulas of the samples used for the experimental data from FIGS. 13 to 40 in Reference 8 were not described in the main text. That is, information about the samples is absent. The lack of these chemical formulas neither supports ‘Chemical Formula 1 in Claim 1’ of Reference 8, nor does it clarify the identity of the experimental data from FIGS. 13 to 40.

Reference 8-2 is a divisional patent of Reference 8. It claims a chemical formula of _{A10-x}Bₓ(PO₄)₆O, where A is Ca, Ba, Sr, Sn, or Pb, B is Cu, Cd, Zn, Mn, Fe, Ni, or Ag, and x ranges from 0.1 to 2.0. Since this chemical formula does not account for sulfur, Reference 8-2 has no impact on present invention. Although Cu₂S planar peaks in X-ray diffraction pattern were observed, its quantity was very small, as mentioned at line 25 in page 8 of reference 8-2, so its role in the chemical formula was neglected. It was mentioned that some or all of sulfur reacts with phosphorous to form a phosphoric acid group at line 3 in page 7of reference 8-2. Accordingly, references 1, 2, 8, and 8-2 assert the existence of a superconductor without sulfur at the oxygen site.

The authors of Reference 2 revealed that sulfur evaporated due to the high synthesis temperature, as written at line 9 of page 3 of reference 2.

At this point, it is unlikely that the structural composition claimed by references 1and 2 is a room temperature, ambient pressure superconductor.

There remains a long-standing need for a composition of matter and its synthesis to achieve a room temperature, ambient pressure superconductor.

### SUMMARY OF THE INVENTION

Diamagnetic superconducting compounds (or materials), which exhibit both a repulsive characteristic on a magnet and critical characteristics in transport measurements at and above 0° C. and ambient pressure, along with their synthesis methods, are described. The key, relative to the prior art, is recognizing the importance of both finding a diamagnetic component containing a significant number of Cu—S and Cu—O bonds and synthesizing it in modified structures of the model A₁₀(BO₄)₆C type.

More specifically, we describe diamagnetic compounds having the molecular formula Pb₁₀₋ₓCuₓ[P(O_{1-y}S_{y})₄]₆O_{1-z}S_{z} (PCPOSOS), where 2.5≤x≤10, 0<y≤1, 0<z≤1. This has a one-dimensional superconducting channel of CuS. Additionally, Pb₁₀₋ₓCuₓ[P(O_{1-y}S_{y})₄]₆O_{1-z}S_{z} can be expressed as Pb₁₀₋ₓCuₓP₆O_{24-24y+1-z}S_{24y+1-z} (PCPOS).

The diamagnetic compounds can be synthesized from at least four elements—Pb, Cu, P, and S—in atmospheric air at a temperature over 1100° C. The amount of sulfur in the resulting crystal structure can be controlled by varying the reaction quench, as well as the reaction time and temperature. The meaning of ‘at least’ indicates powders of respective elements can have impurity elements, although very pure elements of 99.99999% were purchased.

### REPRESENTIVE DRAWING

FIG. 7, FIG. 8, FIG. 9

BRIEF DESCRIPTION OF DRAWINGS AND TABLE

FIG. 1 shows a schematic image of the general structure of diamagnetic compounds described herein, with an overhead view as the top image presented as (a), and a side view as the bottom image presented as (b).

FIG. 2 shows XRD patterns of CuS nanoflakes formed with different Cu: S ratios:(A) 1:1 and (B) 1:5. Bottom plot: X-ray reflections of bulk covellite (CuS) phase (JCPDS No. 79-2321) are shown with a stick spectrum.

FIG. 3 shows heat treatment methods for synthesis of the diamagnetic compounds.

FIG. 4 shows the relationship between diamagnetic susceptibility (χ_{dia}<0) and ferromagnetic or paramagnetic susceptibility (χₚₐᵣₐ>0) in a type-II superconductor above a critical magnetic field.

FIG. 5 shows full levitation as a diamagnetic phenomenon measured in a PCPOSOS sample. The levitation was observed using a magnification of 1600× on three coins placed on a magnet. This was cited in reference 13.

FIG. 6 shows zero resistance measured in a PCPOS sample during I-V measurements, as cited in reference 14.

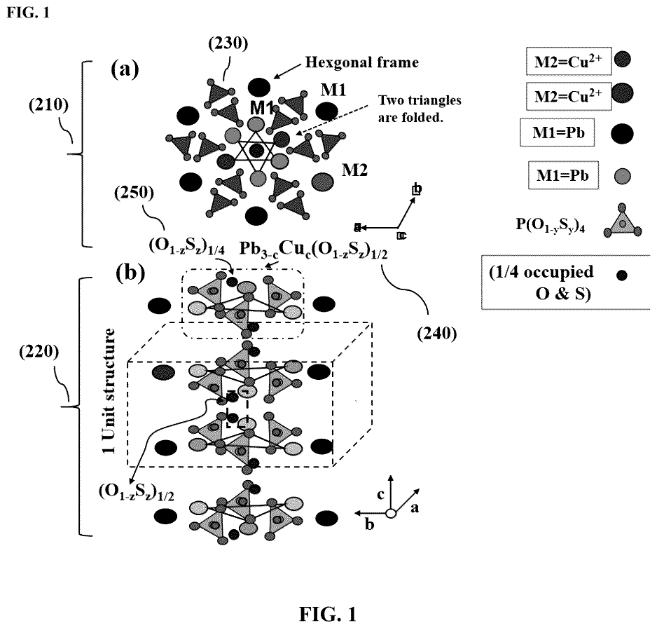

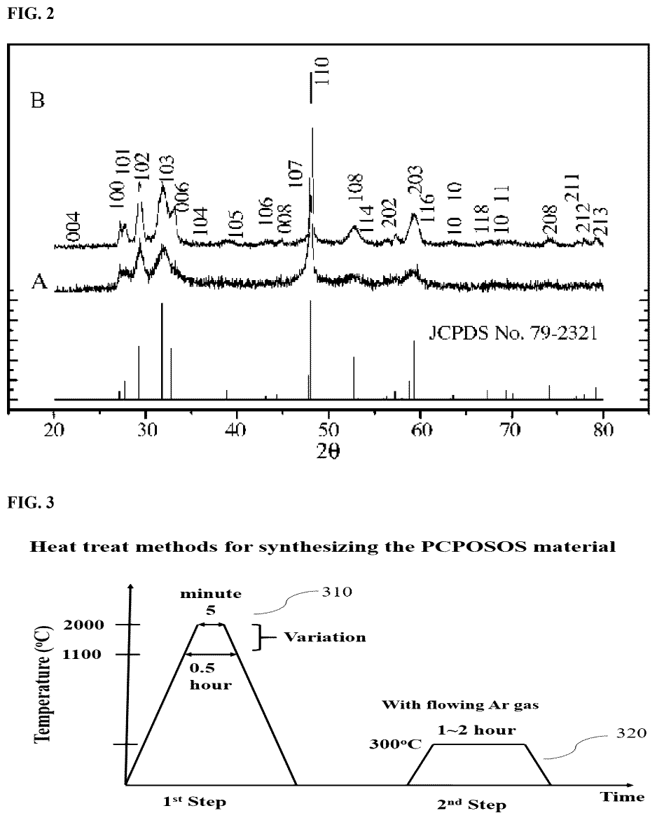

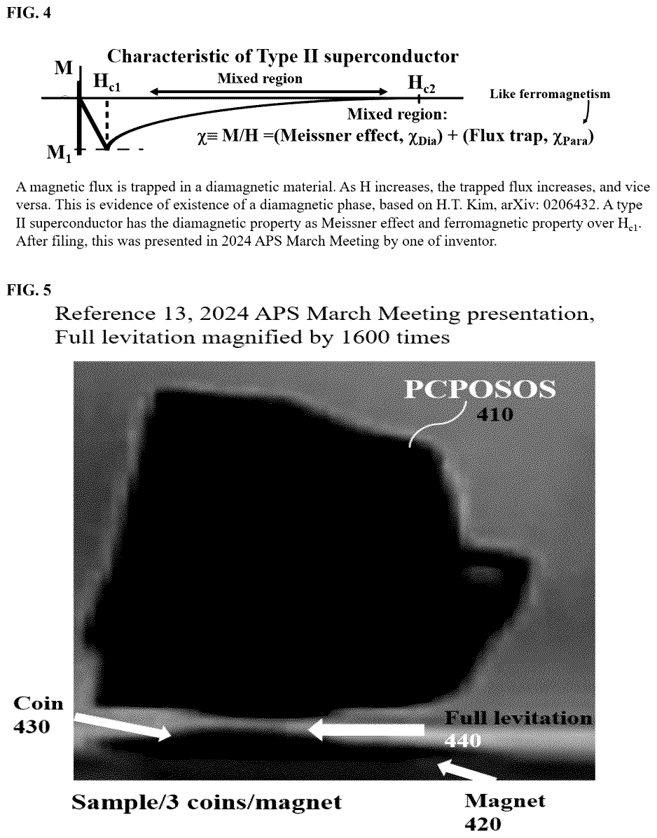

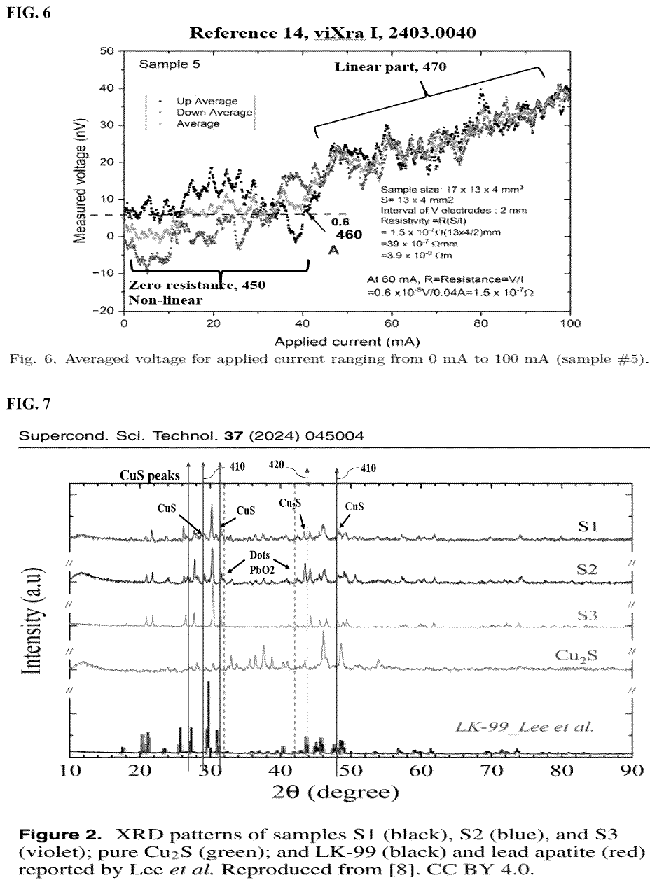

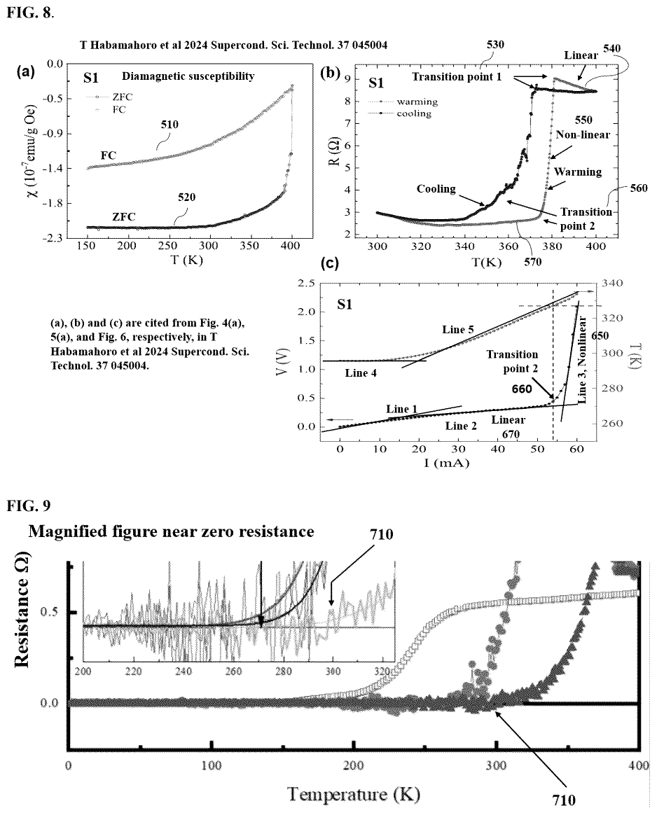

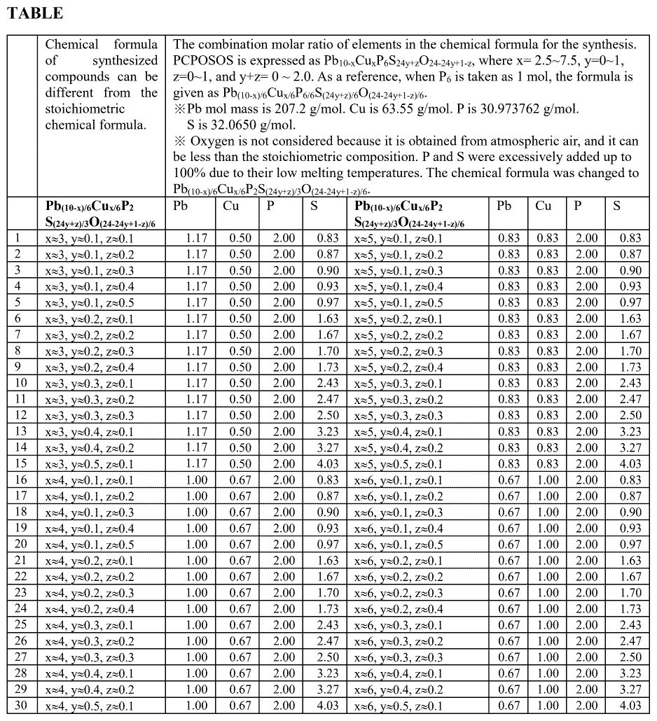

FIG. 7 shows CuS planar peaks in the X-ray diffraction pattern of sample SI doped by sulfur to Pb₁₋ₓCuₓ(PO₄)₆O. The data was cited in reference 6.

FIG. 8 shows diamagnetic susceptibility, critical transition points at boundary between linear and nonlinear behaviors in transport data for sample S1. The data were cited in reference 6.

FIG. 9 shows zero resistance measured in a sulfur-doped material, such as PCPOSOS, which was disclosed by the YaoYao group in China on an internet site.

Table 1 shows the molar ratios of elements in the chemical formula used for synthesizing the diamagnetic compounds, as possible examples.

BRIEF DESCRIPTION OF DRAWINGS AND TABLE Invention of CuS channel

The diamagnetic compounds, which exhibit both a repulsive characteristic on a magnet and critical characteristics in transport measurements such as resistance at and above 0° C. and ambient pressure, are described, as well as methods for their characteristic structure, synthesis and applications thereof.

The diamagnetic compounds can have a lead apatite structure of the model A₁₀(BC₄)₆C type, wherein A is lead (Pb) and/or copper (Cu), B is phosphorus (P), and C is oxygen (O) and/or sulfur(S). An idea of this invention is that sulfur is substituted for the oxygen site. More specifically, we describe compounds having the molecular formula Pb₁₀₋ₓCuₓ[P(O_{1-y}S_{y})₄]₆O_{1-z}S_{z} (PCPOSOS), wherein 2.5≤x≤10, 0<y≤1, 0<z≤1. Since the PCPOSOS compounds in the range of 0<x<2.5 are considered doped Mott insulators, this range is excluded here. In the case of x=10, Pb₁₀₋ₓCuₓ[P(O_{1-y}S_{y})₄]₆O_{1-z}S_{z} becomes Cu₁₀[P(O_{1-y}S_{y})₄]₆O_{1-z}S_{z}, which has the electronic structure of a metal due to Cu²⁺(3d⁹). Therefore, the range of x is determined to be 2.5≤x≤10.

In the case of PCPOSOS, since oxygen can be completely replaced by sulfur due to having the same outermost valence, the ranges of y and z can be determined as 0 ≤y≤1 and 0≤z≤1.

Additionally, Pb₁₀₋ₓCuₓ[P(O_{1-y}S_{y})₄]₆O_{1-z}S_{z} can also be expressed as Pb₁₀₋ₓCuₓP₆O_{24-24y+1-z}S_{24+z}(PCPOS). As an example, when x=3, y=0.1, and z=0.1, Pb₇Cu₃[P(O_{0.9}S_{0.1})₄]O_{0.9}S_{0.1} is expressed as Pb₇Cu₃P₆O_{22.5}S_{2.5}. Various chemical formulas for combinations of x, y, and z can be expressed, as shown in Table 1.

The structure of a diamagnetic compound Pb₁₀₋ₓCuₓ[P(O_{1-y}S_{y})₄]₆O_{1-z}S_{z} is shown in FIG. 1. The top image (210) in FIG. 1 shows a top schematic view of the chemical structure, while the bottom image (220) shows a side view. The tetra-phosphate-sulfur ion (230) is P(O_{1-y}S_{y})₄, which is located between Pb or Cu elements in the inside and outside hexagonal structures. It plays a role as a connector connecting the Pb or Cu elements and maintains a form of the apatite structure. The inside unit layer of Pb_{3-c}Cu_{c}(O_{1-z}S_{z})_{1/2} (240) in the bottom image is composed of both the Pb_{3-c}Cu_{c} plane and (O_{1-z}S_{z})_{1/2} as a summation of two (O_{1-z}S_{z})_{1/4s} located slightly above and below the Pb_{3-c}Cu_{c} plane. The position of (O_{1-z}S_{z})_{1/4} (blue ball) (250) in the bottom (side-view) image of view of FIG. 1 is located at positions slightly above and slightly below the Pb_{3-c}Cu_{c} plane.

With respect to the diamagnetic compound, the decomposition of the chemical formula (Pb₁₀₋ₓCuₓ[P(O_{1-y}S_{y})₄]O_{1-z}S_{z}) (PCPOSOS) can be represented by FIG. 1 and the following chemical formula:

Pb₁₀₋ₓCuₓ[P(O_{1-y}S_{y})₄]₆(O_{1-z}S_{z})=[Pb₄₋ₐ Cuₐ[(P(O_{1-y}S_{y})₄)_{(8/3)}]]^{F}+[Pb_{6-b}Cu_{b}[(P(O_{1- y}S_{y})₄)_{(10/3)}](O_{1-z}S_{z})]^{T}, where a+b=x=[Pb₄₋ₐCuₐ[(P(O_{1-y}S_{y})₄₎)_{(8/3)}]]^{F}+[Pb_{3-c}Cu_{c} [(P (O_{1-y}S_{y})₄)_{(5/3)}](O_{1-z}S_{z})_{1/2}+Pb_{3-c}(Cu_{c}[(P(O_{1-y}S_{y})₄)_{(5/3)}9 (O_{1-z}S_{z})_{1/2}]^{T}, where c=b/2, a and b≈0,=[Pb₄₋ₐCuₐ[(P(O_{1-y}S_{y})₄) _{(2+2/3)}]]^{F}+[Pb_{3-c}Cu_{c}[(P(O_{1-y}S_{y})₄)_{(1+2/3)}](O_{1-z}S_{z})_{1/2}+Pb_{3-c}Cu_{c}[(P (O_{1-y}S_{y})₄)_{(1+2/3)}](O_{1-z}S_{z})_{1/2}]^{T},

where, uppercase ‘F’ represents the frame (outside hexagonal structure of (Pb and Cu)) in top view (210) of FIG. 1, and uppercase ‘T’ (inside hexagonal structure of (Pb and Cu)) in top view (210) of FIG. 1 indicates the tunneling part. Tetra- phosphate-sulfur P (O_{1-y}S_{y}) 4 ion 230 contributes to the formation of the hexagonal structure in apatite, bonding Pb and Cu. When the frame and tetra-phosphate-sulfur P (O_{1-y}S_{y}) 4 ions are excluded, what remains is Pb_{3-c}Cu_{c}O_{1-z}S_{z} (240) in the T structure. Pb_{3-c}Cu_{3-c}O_{1-z}S_{z} (240) is decomposed as PbO, PbS, CuO, CuS. PbS and PbO do not generate carriers because Pb⁺² (5d¹⁰6s²) has a filled band. However, CuO_{1-z}S_{z} produces conducting carriers. In this case, Cu⁺²O (3d⁹) or Cu⁺²S (3d⁹) behaves as a hole-type metal. This indicates that the PCPOSOS has metallic characteristics of CuO and CuS, but it is not CuO and CuS phases.

Based on prior art information, doped CuO_{1±k} (0<k<<1) has been shown to exhibit ferromagnetism, while doped CuS_{1±p} (0≤p<0.5) demonstrates superconductive diamagnetism at low temperatures. When CuO_{1-z}S_{z} in the apatite structure is composed of CuO_{1±k} or CuS_{1±p}, it can exhibit both ferromagnetism and diamagnetism, the latter of which is a key characteristic of a superconductor. Moreover, covalent bonding of CuS is easier relative to covalent bonding of CuO, as per Fajan's rule.

The structure of CuS_{1±p}, in contrast to CuO_{1±k}, is likely more susceptible to structural distortion below a critical transition point, leading to superconductive diamagnetism at higher temperatures. The distortion possibly induces superconductivity. A possible explanation for this phenomenon was provided by BR-BCS theory of reference 9 (H. T. Kim (one of inventors), “Room-temperature-super conducting T_{c} (driven by electron correlation”, Sci. Rep. 11 (10329) 2021). Supercurrent for a room-temperature superconductor at atmospheric pressure possibly flows in a one-dimensional channel through Cu in the Pb_{3-c}Cu_{c} plane (240) and S in the O_{1-z}S_{z} (250) component. The one-dimensional superconducting channel can have a critical temperature above room temperature, as explained in Reference 2(arXiv: 2307.12037).

In the case of LK-99 of (Pb₁₋ₓCuₓ(PO₄)₆O, 0.9<x<1.1), as described in reference 8 above, since sulfur is substituted at the phosphorus (P) site, the Cus characteristics invented here do not appear. Therefore, the superconductive diamagnetic compounds are not synthesized—this is a decisive difference from the present invention.

The characteristic feature of this invention is the presence of a planar peak of planes corresponding to CuS_{1±p} (0≤p≤0.5). The planes can be observed by X-ray diffraction experiments. The peaks of the X-ray diffraction in CuS are given by JCPDS 01-079-2321,which shows peaks from planes of (004), (100), (101), (102), (103), (006), (104), (105), (106), (008), (107), (110), (108), (114), (202), (203), (116), (10 10), (118), (1011), (208), (211), (212), and (213), as shown in FIG. 2 cited by reference 10. In the case of JCPDS 06-0464 of Covellite (CuS), 2θ angles of various XRD plains are given as 10.806° for (002), 27.121° for (100), 27.680° for (101), 29.275° for (102), 31.783° for (103), 32.851° for (006), 38.833° for (105), 43.100° for (106), 44.298° for (008), 47.778° for (107), 47.939° for (110), 52.712° for (108), 56.249° for (201), 57.203° for (202), 58.679° for (203), 59.342° for (116), 63.537° for (1010), 67.303° for (118), 69.343° for (1011), 69.993° for (207), 73.992° for (208), 77.769° for (212), 79.073° for (213), 88.911° for (1014), 89.446° for (300), 93.133° for (218), and 98.663° for 306.

Moreover, FIG. 1 of reference 11 (Rajaram R et al., “Amperometric determination of Myo-inositol using a glassy carbon electrode modified with nanostructured copper sulfide”, Microchim Acta (2020) 187:334) disclosed the main 20 peaks of (101) near 27.0° or near 27.7°, (101) near 28.9°, (103) near 31.8°, (003) I near 31.8°, (003) II near 33.0°, (006) near 34.0°, (110) near 47.8°, (108) near 52.0°, and (116) near 58.7°. The positions of the peaks can slightly differ from those of the PCPOSOS compounds depending on the synthesis conditions. We note that because the compound is not CuS, it does not have all planar peaks of CuS.

In some embodiments, higher concentrations of sulfur are included in the crystal structure of the chemical formula. Oxygen and sulfur are not chemically bonded to each other within the crystal structure.

The diamagnetic compounds can be characterized using methods known in the art, and their properties can be characterized and tested for superconductivity using methods known in the art.

### Synthesis Methods

In representative embodiments, the diamagnetic compounds can be synthesized from at least elements of Pb, Cu, P, S in air through applying heat of 1100° C.˜2000° C. for a short time, as shown in FIG. 3, because melting points of Pb, Cu, red-P, S at ambient pressure were known as approximately 327.5° C., 1085° C., 590° C., 115° C., respectively, and boiling points of Pb, red-P, S were known as approximately 1749° C., 620° C., 444.6° C., respectively. One mol mass of Pb is 207.2 g/mol, Cu mol mass is 63.55 g/mol, P mol mass is 30.974 g/mol, S mol mass is 32.0650 g/mol. P and S may evaporate at high temperatures. Since S is an important element, more of it is added in the synthesis process. P is less important than S, and in some cases, P may act as an impurity at high temperatures and may be absent.

When sulfur is melted near copper at a relevant high temperature, the sulfur can be chemically combined with Cu to be CuS or Cu₂S, because CuS has a melting point of 500° C. or Cu₂S has a melting point of 1130° C. Thus a synthesized compound can have characteristics of CuS, Cu₂S, PbS, CuO, and PbO phases. Here, a phase exhibiting the Cus metal characteristic can become the diamagnetic compound, as explained in FIG. 1.

As a possible example, the combination molar ratios of elements in the chemical formula for the synthesis of the diamagnetic compounds are given in Table 1.

The mixing rate of the elements follows the ratio of x, y, z given in the chemical formula. In synthesizing compounds, P and S can be excessively added by over 100% due to low melting temperature. After transferring a powder mixed with at least Pb, Cu, P, S elements to an alumina or platinum crucible, the powder sample is placed in a furnace or a heat source of a temperature of over 1100° C. for 5˜30 minutes reaching the target temperature; this is 1^{st} stage (310), as shown in FIG. 3. As the heating temperature increases over 1100° C., the heating time can decrease to 5 minutes. The sample can be cooled, removed from the furnace or the heat source.

In the second stage (320) of the synthesis, a second heat treatment with flowing Ar gas is performed to extend the metal region (percolation) in the sample and avoid contact with oxygen, as shown in FIG. 3. Furthermore, the second heat treatment may be carried out by applying a high current.

It is believed that the substitution of a sulfur atom for an oxygen atom increases the compound's diamagnetic susceptibility.

### EMBODYMENTS OF THE INVENTION

Diamagnetic compounds can have zero electrical resistance, which means they can carry electric current without any energy loss due to resistance. This property can revolutionize power transmission and distribution, leading to more efficient electrical grids and reduced energy consumption.

After filing of the provisional patent, one of inventors announced results of present invention at 2024 American Physical Society (APS) March meeting of reference 12 (Abstract: A16.00002_“Partial levitation, type-II-superconductor characteristic, at room temperature and atmospheric pressure in PCPOSOS”). The key presentation screens broadcasted by internet are attached as reference 13. Papers were announced by reference 14 (H. Kim et al., “The Potential Zero-Resistance Phenomenon of the Pb—Cu—P—S—O Compound and Its Synthesis Method”, viXra 2403.0040 v2) and reference 15 (H. Kim et al., “Investigation of the Zero Resistance and Temperature-Dependent Superconductivity Phase Transition in Pb—Cu—P—S—O Compound”, viXra 2403.0144 v2).

In these announcements, the characteristics of the diamagnetic compound-such as partial levitation, full levitation (440, FIG. 5), zero resistance, and sample synthesis-were presented. The full levitation (440, FIG. 5, reference 13) was measured on three coins (430) of a magnet (420) for a PCPOSOS sample (410). This was observed using a magnified lens at 1600×, with genius insight from Daccheul Jung in the Superconductor Lab in South Korea. FIG. 6 demonstrates the zero resistance (450), regarded as the non-linear part, with dV/dI≡R=0, the linear part (470), and the critical point (460), as shown in reference 14.

In these announcements, the mechanism emphasizing the importance of the Cus characteristics was discussed, and the synthesis method was also disclosed. The levitation behaviors are characteristic of diamagnetism. The diamagnetic compounds are regarded as type-II superconductors, which exhibit two types of magnetism: diamagnetism (susceptibility χ_{dia}<0, repulsive) and a magnetism like ferromagnetism (χₚₐᵣₐ>0,attractive), as shown in FIG. 4 and Reference 13.

The diamagnetic compounds exhibit metallic behavior above a critical transition point, on the boundary between linear and non-linear characteristics, in transport measurements at and above 0° C. The linear characteristic refers to the Ohmic property of metals, while the non-linear characteristic arises from the condensed state with an energy gap. When energy is destroyed or formed during a gap-no-gap transition, a discontinuous jump, regarded as having non-linear characteristics, is produced.

Another example of enablement is introduced. FIGS. 7 and 8, as cited in Reference 16, published on Feb. 29, 2024, show both CuS (400) as well as Cu₂S (405) planar peaks in the X-ray diffraction (XRD) pattern in Sample S1 [FIG. 7], diamagnetic susceptibility (510, 520), and critical transition points (530, 560, 660) between lincar part (540, 570, 670) and non-linear part (550,650) in the transport data for sample S1 [FIG. 8], although the data does not show zero resistance. The CuS XRD peaks (400) can be a peak claimed in claim 1. Generally, in one-dimensional materials, measuring zero resistance is very difficult because the measurement itself is not one-dimensional. Sample SI was a material doped with sulfur to form Pb₁₋ₓCuₓ(PO₄)₆O, although the x value was not disclosed. Sample S1 can be regarded as the correct sample explained in present invention. The resistance drops and the linear behavior near a critical transition point is a characteristic of CuS in PCPOSOS, not Cu₂S which has no the linear property, as shown in FIGS. 8(b) and 8(c). The absence of the linear property in Cu₂S is attributed to its undergoing a structural phase transition between (γ-semiconductor) and (β-semiconductor) near 116° C., as mentioned in Reference 6. Generally, the structural phase-transition point does not change and remains constant, even when heat is applied. However, FIG. 8(b) shows a decrease in the transition temperature during the cooling process, in which the heat applied during the heating process-exceeding the transition temperature-is released. This is decisive evidence that the reduction in resistance originates from CuS, not Cu₂S. Furthermore, it is deduced that, when significantly more heat is applied, the transition temperature will decrease substantially, and Ohmic behavior with a positive slope above the transition temperature will appear. This is the percolation phenomenon. Accordingly, these indicate that sulfur is substituted at the oxygen site, as proposed in present invention.

Another example of enablement is introduced. A zero resistance by 300 K (27° C.)

(710), measured for a sulfur-doped sample such as PCPOSOS, is shown in FIG. 9. This is a figure disclosed on September of 2024 at an internet site

(https://www.zhihu.com/column/c_1670928545139486720) in china by YaoYao group in China.

Other applications include use of diamagnetic compounds to develop compact and lightweight high-field magnets, which have applications in medical imaging (e.g., MRI machines) and particle accelerators.

The diamagnetic compounds described herein can be used to develop highly efficient and powerful magnetically levitated (maglev) trains and other transportation systems, reducing friction and energy consumption.

Diamagnetic compounds can be used to produce ultra-sensitive detectors and sensors, which can have applications in fields like astronomy, medical imaging, and security

Diamagnetic compounds can be employed in the generation and storage of renewable energy, such as wind turbines and energy storage systems, to improve the overall efficiency of these technologies.

The lightweight, high-performance diamagnetic compounds could improve the efficiency and capabilities of aerospace systems and propulsion technologies.

The diamagnetic compounds described herein could facilitate more energy-efficient and faster electronic devices, including consumer electronics such as smartphones.

Herein, the compound structure was modeled on the basis of a modified apatite structure. However, in the real compounds, the true structure can be unclear or may not be apatite because the melting temperatures of P and S are low. The compounds can be non-stoichiometric and inhomogeneous. Nevertheless, we have claimed a phase such as the diamagnetic compound exhibiting the CuS characteristics, regardless of the assumed structure.

Thin films of the diamagnetic compounds can be deposited by sputtering, pulsed laser deposition, sol-gel method, thermal evaporation, and molecular beam epitaxy, etc.

### INCORPORATION BY REFERENCE

All publications, patents, and patent applications cited herein are hereby expressly

incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e., to at least one) of the grammatical object of the article. By way of example, “a superconductor” means one superconductor or more than one superconductor.

Any ranges cited herein are inclusive, e.g., “between 0 and 1” includes both 0 and 1.

### DESCRIPTION OF SIGNS

210: Top view of apatite structure
220: Side view of apatite structure
230: Tetra-phosphate-sulfur ion
240: Lead-Copper-Oxygen-Sulfur, Pb_{3-c}Cu_{c}(O_{1-z}S_{z})_{1/2}
250: Oxygen Sulfur ion, O_{1-z}S_{z}
310: First stage in synthesis method
320: Second stage in synthesis method
400: CuS X-ray diffraction (XRD) peak
405: Cu₂S XRD peak
410: PCPOSOS Sample
420: Magnet
430: Three Coins
440: Full levitation
450: Zero resistance (noise, non-linear part)
460: Transition point, A
470: Linear part
510: Field cool (FC) in magnetic susceptibility
520: Zero field cool (ZFC) in magnetic susceptibility
530: Transition point 1 in R-T curve
540: Linear part in R-T curve
550: Non-linear part in R-T curve
560: Transition point 2 in R-T curve
570: Linear part in R-T curve (when signal is magnified, the linear part will be

obvious)
650: Non-linear part in I-V curve
660: Transition point 2 in I-V curve
670: Linear part in I-V curve
710: Zero resistance

1. Diamagnetic compounds, comprising at least the elements Pb, Cu, S, and O, characterized by a planar peak from CuS planes in the X-ray diffraction pattern, as well as the critical transition point at the boundary between linear and non-linear characteristics in transport measurements at and above 0° C. and ambient pressure.

2. For claim 1,
diamagnetic compounds comprising a chemical formula of Pb₁₀₋ₓCuₓ[P(O_{1-y}S_{y})₄]₆O_{1-z}S_{z}, wherein 2.5≤x≤10, 0<y≤1, 0 <z≤1.

3. For claim 1,
diamagnetic compounds comprising a chemical formula of Pb₁₀₋ₓCuₓP₆O_{24-24y+1-z}S_{24y+z}, wherein 2.5≤x≤10, 0<y 23 1,0<z≤1.

4. In the second stage of heat treatment for synthesis of the diamagnetic compound, a method for increasing the temperature by applying current to the diamagnetic compound synthesized in the first stage.
